(19) United States
(12) Patent Application Publication
(10) Pub. No.: US 2009/0095848 A1
(43) Pub. Date: Apr. 16, 2009

(54) Device for hanging decorative lighting

(75) Inventors: Paul Robert Holbrook, Buffalo Grove, IL (US); Trevor Jackson, Kirtland, OH (US)

Correspondence Address: PAUL HOLBROOK, 2218 MIRAMAR LANE, BUFFALO GROVE, IL, 60089, US

(73) Assignee: PRH DESIGN LLC

(21) Appl. No.: 12/287,138

(22) Filed: Oct. 7, 2008

Related U.S. Application Data
(60) Provisional application No. 60/998,387, filed on Oct. 11, 2007.

(51) Int. Cl. F16L 3/06

(52) U.S. Cl. 248/74.2

(57) ABSTRACT

System to easily install and remove hangers for a string of decorative lights around a house, while standing on the ground and without requiring the use of a ladder. The system is particularly intended for attachment to gutter lips. The system is comprised of two components: a spring-loaded hanger clip which holds the light string and an elongated staff with hanger clip actuator at the distal end to temporarily hold the clip until it can be positioned and installed on the gutter lip. The elongated staff has an actuating means which opens and closes the jaw of the hanger clip. In use, the user would first attach the light string to the hanger clip which grips it securely. The clip is then temporarily and securely attached to the elongated staff by inserting the clip onto the distal end of the staff. Utilizing the staff, the user uses the actuating means to open the hanger clip jaw and then positions the clip on the gutter lip. The actuating means are used again to close the jaw of the hanger clip, allowing the clip to be firmly attached to the gutter lip. For removal of the light string, the reverse process is followed.

### RELATED APPLICATIONS

This application is the non-provisional application related to my provisional application 60/998,387 filed Oct. 11, 2007.

### FEDERALLY SPONSORED RESEARCH/DEVELOPMENT

None

### MICROFICHE APPENDIX

None

### BACKGROUND OF THE INVENTION

1. Field of the Invention

The present invention relates to a method of installing and displaying decorative lights, such as a continuous strand of decorative lights, around a house, while standing on the ground, and without the necessity of having to use a ladder.

2. Prior Art

My U.S. Pat. No. 6,347,780 specifically addresses a solution to this problem. This application constitutes an improved version of this design, specifically an improved hanger clip design which is specifically designed to contour to and grip a wide variety of gutter lips more securely.

### SUMMARY OF THE INVENTION

This invention provides a system to easily install and remove hangers for a string of decorative lights around the outside of a house, while standing on the ground and without requiring the use of a ladder. The system is particularly intended for attachment of lights to gutter lips. The system is comprised of two components, a spring-loaded hanger clip which attaches to the gutter lip and holds the decorative light string, and an elongated staff with hanger clip actuator at one end (hereinafter referred to as the distal end) to temporarily hold the clip while it is being positioned and installed on the gutter lip. The elongated staff has an actuating means which opens and closes the jaw of the hanger clip. In the preferred embodiment, the actuating means is a string connecting the hanger clip actuator to an operating means at a further end (hereinafter referred to as the butt end). The user pulls the string, causing the hanger clip jaw to open. The clip is then positioned on the gutter lip, and the string is released, causing the clip jaw to close and firmly grip the gutter. The preferred embodiment would have a series of identical such hanger clips. In the preferred embodiment, the distal end of the elongated staff and the hanger clip components are made from low cost plastic parts which could be either extruded or injection molded.

In the preferred embodiment, the jaw of the hanger clip is spring loaded and biased in the normally closed position, and the hanger clip actuator is also spring loaded and biased in the normally open position. Also in the preferred embodiment, the hanger clip jaw is designed to fit securely on gutters made from a variety of materials and sizes, such as aluminum and vinyl gutters.

In use, the user would first attach the light string to the hanger clip which grips it securely. The clip is then temporarily and securely attached to the elongated staff by inserting the clip onto the distal end of the staff. Utilizing the staff, the user then pulls the string which opens the jaw of the hanger clip, then positions the clip on the gutter lip. The string is then released, and the spring force of the hanger clip spring causes the hanger clip jaw to close, allowing the hanger clip to securely grip the gutter lip. The spring loaded action of the hanger clip actuator causes it to return to the full open position, releasing the hanger clip. The clip is now securely attached to the gutter lip.

In the preferred embodiment, the distal end of the elongated staff is lockably rotatable, to provide users the option of using the device while not standing directly beneath the gutter lip. This feature may be desirable when there are obstructions directly beneath the gutter, such as shrubs or plantings.

For removal, the reverse process if followed.

In the preferred embodiment, the jaw is slidably retained in the clip body, and an extension spring is used to provide the force to keep the jaw securely closed on the gutter lip.

### BRIEF DESCRIPTION OF THE DRAWINGS

The foregoing aspects and other features of the present invention are explained in the following description, taken in combination with the accompanying drawings, wherein:

FIG. 1 shows a perspective view of the elongated staff assembly and hanger clip. The elongated staff, typically 6 feet long or longer when in use, is shown in broken view for clarity.

FIG. 2 shows a close-up view of the distal end of the elongated staff and the hanger clip.

FIG. 3 shows a close-up view of the distal end of the elongated staff and the hanger clip from another perspective.

FIG. 4 shows a section view of the two portions of the elongated staff and the hanger clip.

FIG. 5 shows a close-up section view of the distal end of the elongated staff and the hanger clip.

FIG. 6 shows a perspective view of the hanger clip with portion of light string attached.

FIG. 7 shows a perspective view with the distal end of the elongated staff installed onto the hanger clip (with light string attached).

FIG. 8 shows a perspective view of the distal end of the elongated staff, with the string pulled.

FIG. 9 shows a perspective view with the elongated staff and hanger clip positioned near an aluminum gutter lip.

FIG. 10 shows a perspective view with the elongated staff and hanger clip positioned on the aluminum gutter lip, ready to be attached.

FIG. 11 shows a perspective view with the string released, and the clip firmly attached to the gutter.

FIG. 12 shows a perspective view with the distal end of the elongated staff removed from the hanger clip, leaving the clip with light string installed on the gutter.

FIG. 13 shows a perspective view of the hanger clip installed on a vinyl gutter having a larger lip height.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION OF THE INVENTION

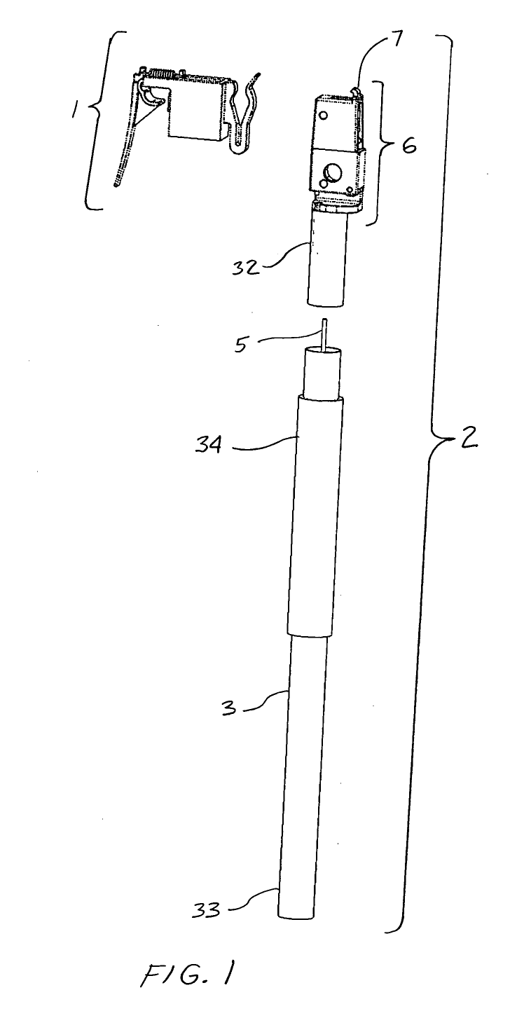

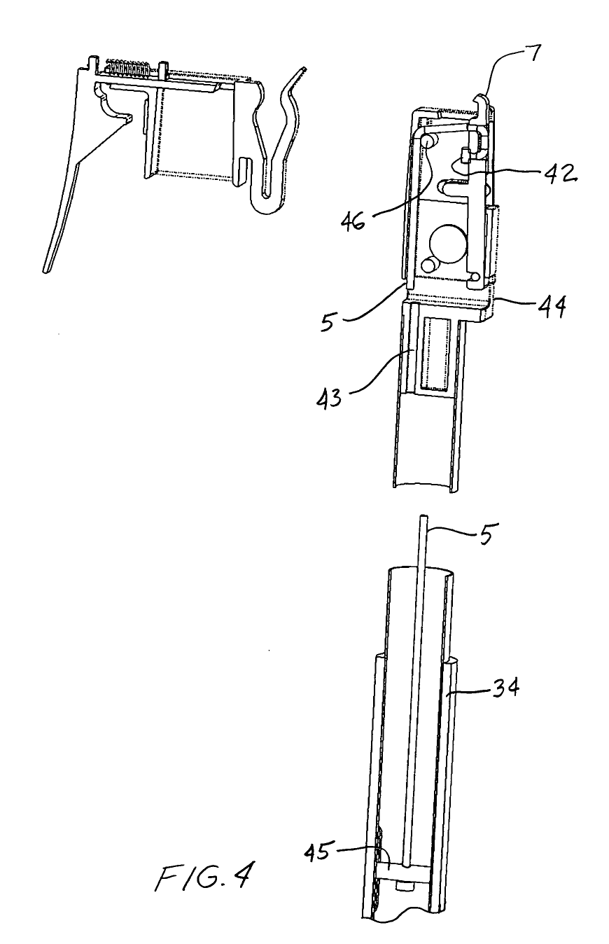

Referring to FIG. 1, there is shown a perspective view of hanger clip assembly 1 and elongated staff assembly 2. The staff assembly 2 is typically 6-8 feet long or longer and may either be a fixed length or an extension type pole commonly found in the art. The staff assembly 2 (shown in broken view of two sections for clarity) is comprised of staff 3 (having a distal portion 32 and a butt portion 33), distal end 6, string 5 and hanger clip actuator 7. String 5 connects to actuator 7 at the distal end of the staff (see FIG. 4) at point 42. The other end of string 5 is accessible to the user holding the butt end 33. In the embodiment shown, the end of the string accessible to the user is connected to hand slider 34, which allows users to open and close the jaw of the hanger clip 1 while keeping both hands on the staff for a secure grip. In alternate embodiments, the string 5 may be on the outside of the pole and could be hanging freely or attached to the butt portion 33 for alternate access by the user.

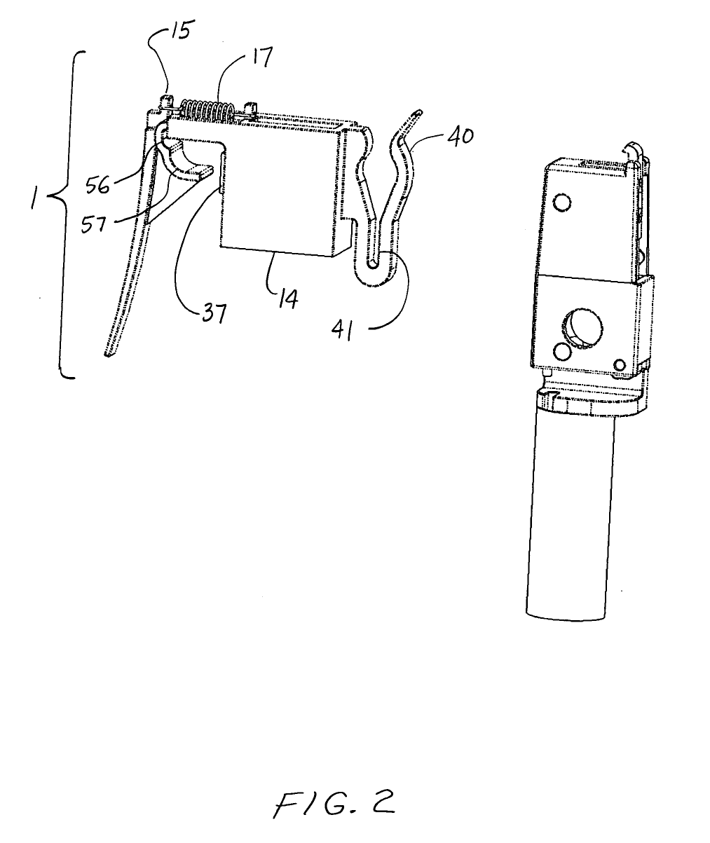

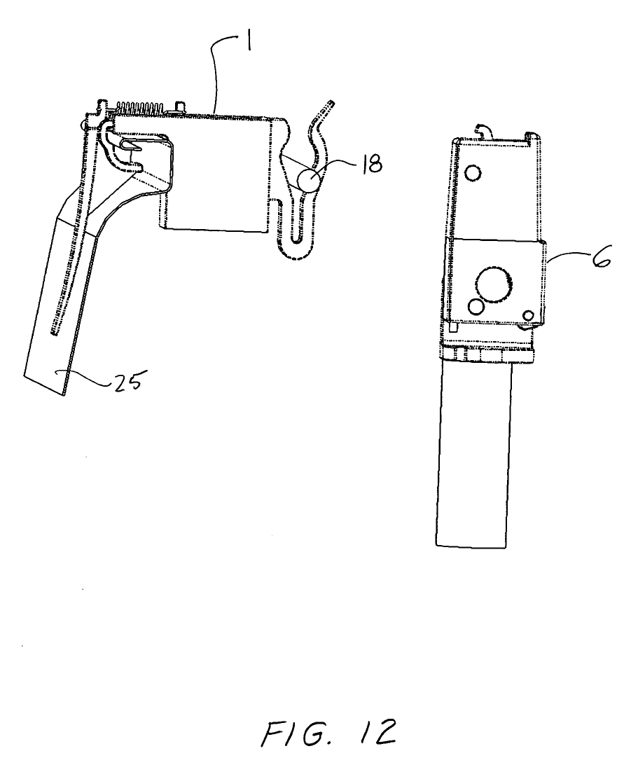

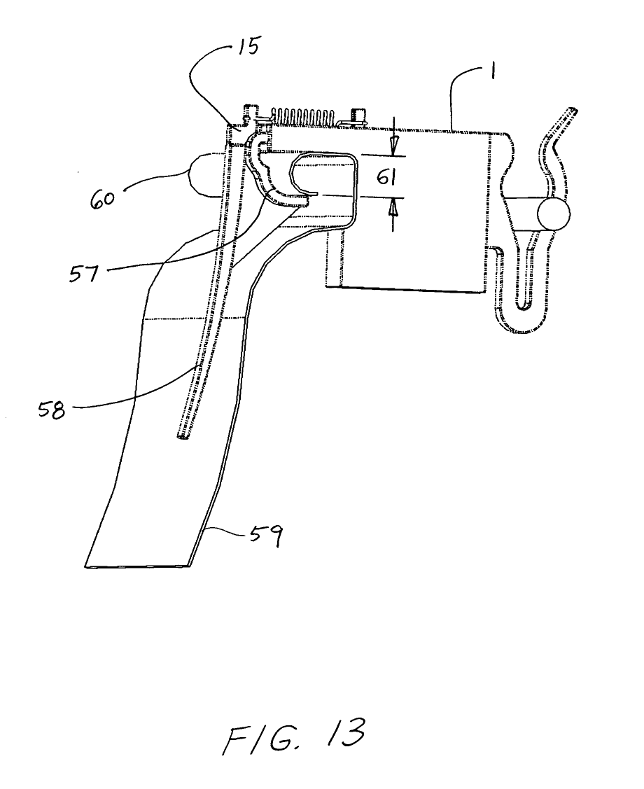

Referring now to FIG. 2, hanger clip assembly 1 is comprised of clip body 14, extension spring 17 and jaw 15 which is slidably mounted in clip body 14. In the preferred embodiment, clip body 14 may have a resilient portion 37 to help securely grip the gutter lip to prevent slippage. Also in the preferred embodiment, jaw 15 has two grooves, 56 and 57, which are specifically designed to contour to aluminum and vinyl gutter lips respectively to grip securely (see FIGS. 12 and 13). Extension spring 17 biases the jaw 15 in a normally closed position. Clip body 14 has light string retainer feature 40 to secure a light string to the clip. In use, a user would force the light string down into opening 41 where it is securely held in place.

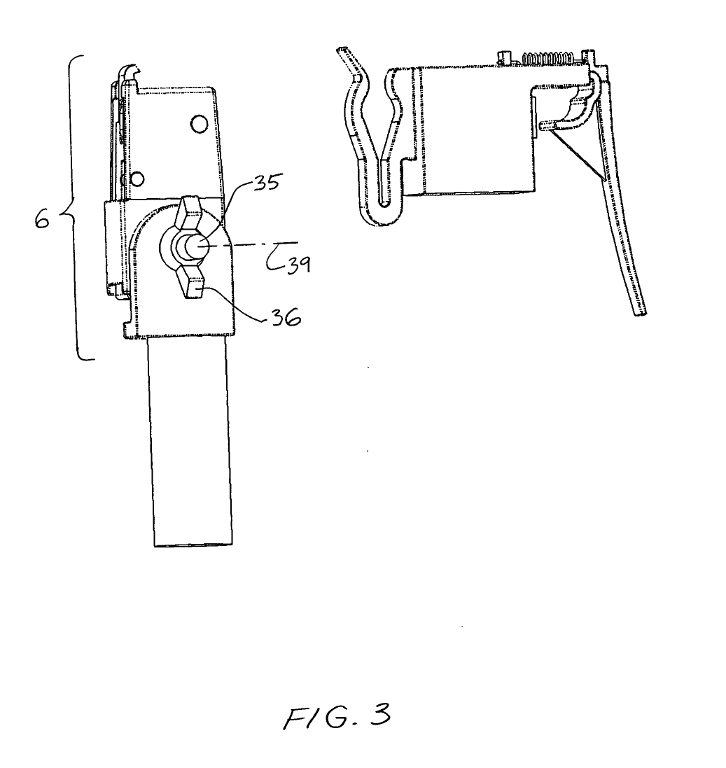

Referring now to FIG. 3, in the preferred embodiment the distal end of staff 6 may be adjustably rotated on the distal portion 32 of staff 3 (see FIG. 1) about axis 39 of bolt 35 by loosening fastener 36 and then re-tightening at the desired angle. Such an adjustment allows users to attach and remove hanger clips from a gutter lip while not standing directly beneath the gutter. Such an option may be advantageous in the case where there are obstructions directly beneath the gutter, for example shrubbery or beds of flowers.

In an alternate embodiment, the distal end of staff 6 is fixed to the distal portion 32 of staff in a non-rotatable manner.

Referring now to FIG. 4, string 5 is attached to actuator 7 at point 42, passes around pin 46, through hole 43 in pole cap 44, and attaches to pin 45 of hand slider 34.

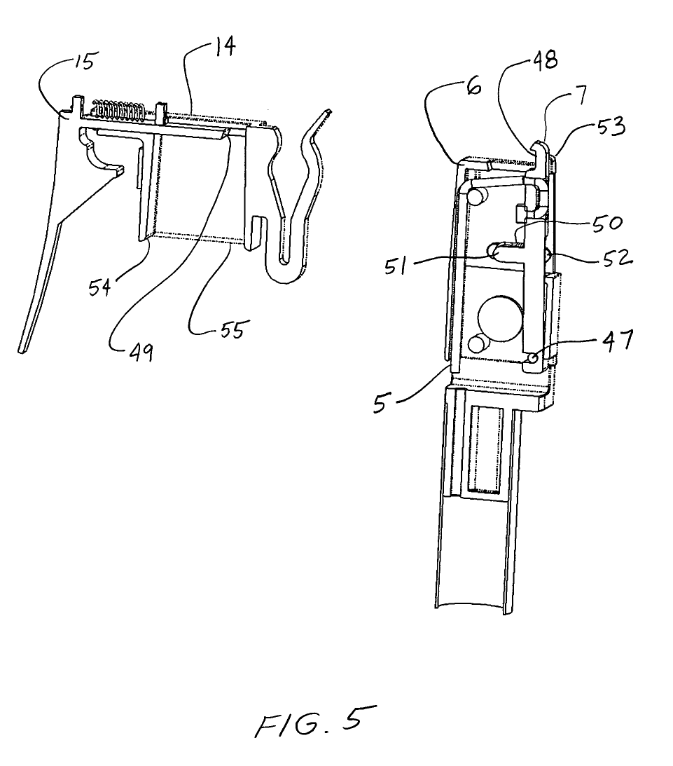

Referring now to FIG. 5, actuator 7 pivots about pin 47. When string 5 is pulled, hook portion 48 engages end 49 of jaw 15, causing the jaw to slide open. Upon string release, actuator spring 50, which is connected between post 51 of actuator 7 and pin 52 of distal end of staff 6, causes actuator 7 to return to the open position. Distal end 6 has rounded top edges 53, and clip body 14 has similarly rounded bottom edges 54 at opening 55 to aid in insertion of the distal end 6 into the clip body 14.

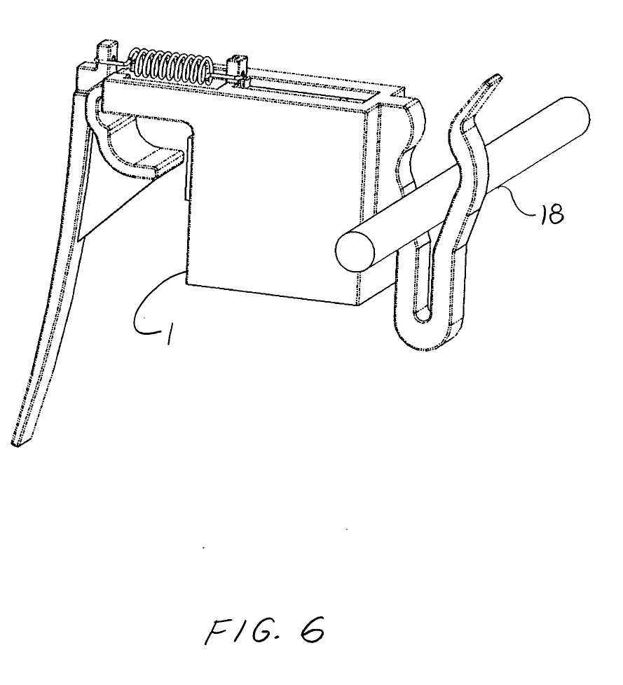

Referring now to FIG. 6, light string 18 has been attached to clip assembly 1.

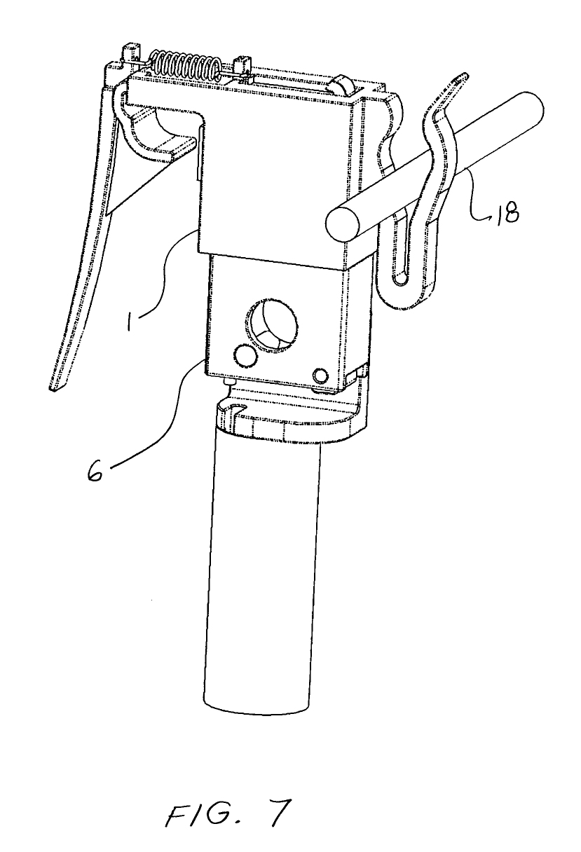

Referring now to FIG. 7, clip assembly 1 with light string 18 attached has been installed onto distal end 6.

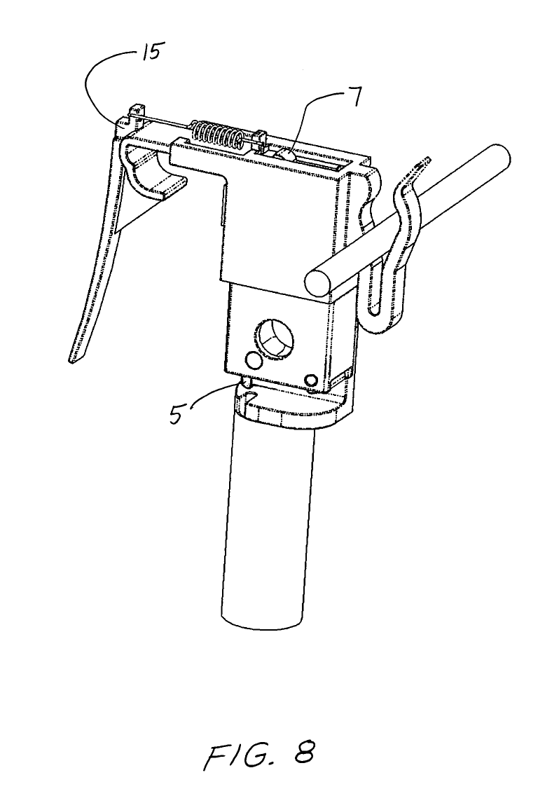

Referring now to FIG. 8, string 5 has been pulled, causing actuator 7 to engage end 49 of jaw 15 (see FIG. 5), sliding jaw 15 open.

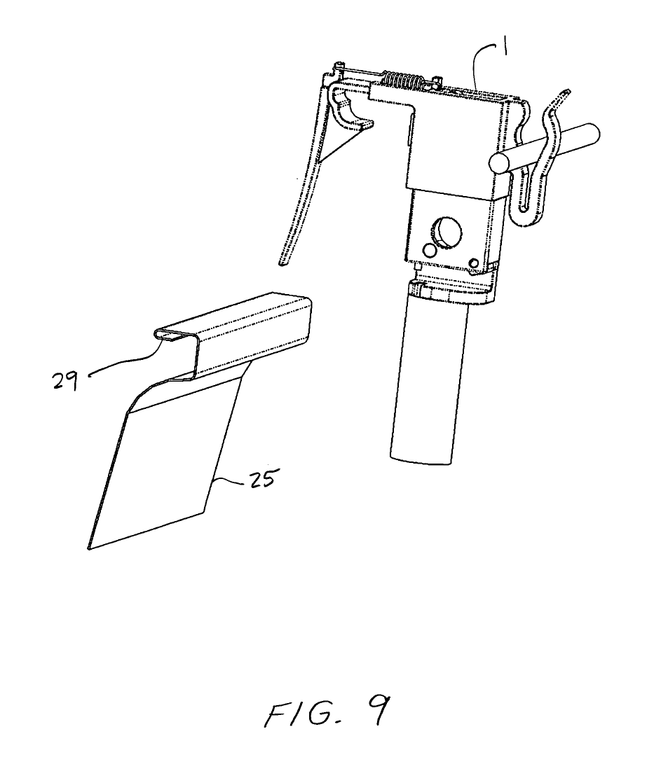

Referring now to FIG. 9, the staff with clip assembly 1 installed has been positioned near an aluminum gutter 25 having lip portion 29.

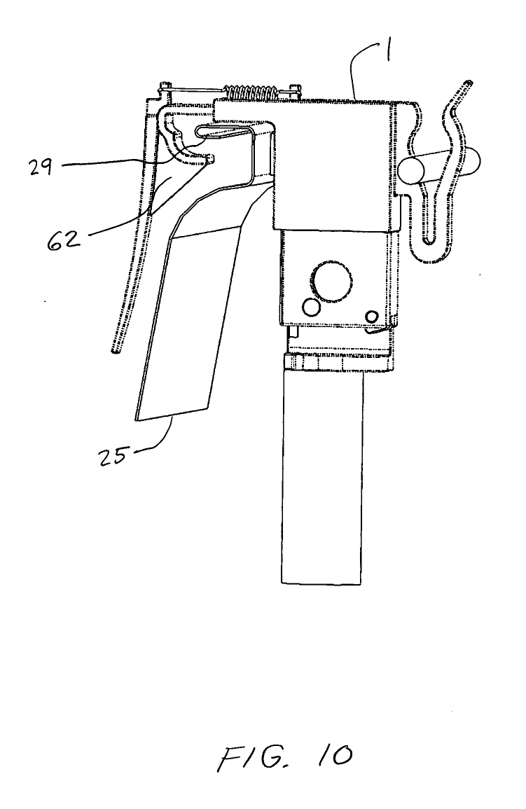

Referring now to FIG. 10, clip assembly 1 has been rested on top of lip portion 29 of aluminum gutter 25. During this process, rib 62 helps guide gutter lip 29 into jaw opening.

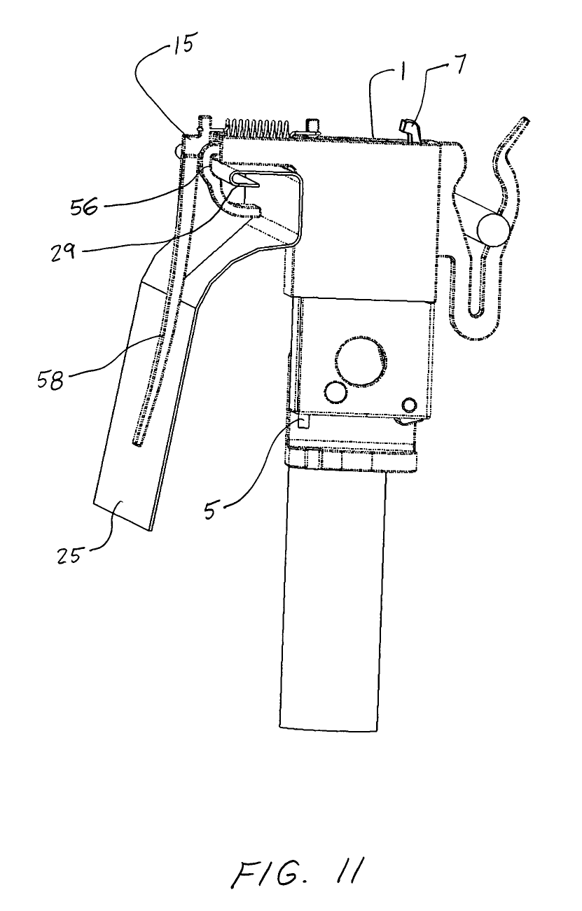

Referring now to FIG. 11, string 5 has been released, causing jaw 15 of clip assembly 1 to securely grip lip portion 29 of aluminum gutter 25 at groove 56, and also allowing actuator 7 to return to the open position. Tail portion 58 is flexible and rests against inside wall of gutter 25 to prevent the clip assembly 1 from rotating in a counterclockwise fashion and becoming disengaged from the gutter lip 29.

Referring now to FIG. 12, the distal end 6 has been removed from the clip assembly 1, leaving the clip assembly 1 with light string 18 attached securely installed on the aluminum gutter 25.

Referring now to FIG. 13, clip assembly 1 is shown installed on a vinyl gutter 59, which has a lip portion 60 of vertical dimension 61 larger than that of aluminum gutters. Lip portion 60 rests in larger groove 57 of jaw 15 and thus grips it securely. Tail portion 58 has a range of flexibility that also allows it to rest against inside wall of vinyl gutter 59 to prevent clip assembly 1 from rotating counterclockwise and becoming disengaged from the gutter lip 60.

For removal of the light string, the reverse process is followed.

What is claimed is:

1. Device for installing and removing hangers for strings of decorative lights to a house, comprising:
A hanger clip having a spring loaded jaw, with said jaw biased in the normally closed position, with said hanger clip having a light string retainer, and
an elongated staff for installing and removing said hanger clip having a hanger clip actuator disposed at one end of said elongated staff to open and close said spring loaded jaw, operating means at a further end of said elongated staff, and actuating means connecting said operating means and hanger clip actuator, such that when said actuating means is in a first given position, said hanger clip actuator closes said hanger clip jaw, and when said actuating means is actuated to an alternate position, said hanger clip actuator opens said hanger clip jaw.

2. A device as described in claim 1, wherein said hanger clip actuator is a spring loaded member biased in the normally open position, such that when said actuating means is actuated to said alternate position, said spring of said member is actuated, thereby closing said spring loaded member and opening said hanger clip jaw, and when said actuating means is released, said spring of said member causes said member to return to full open position, thereby allowing said hanger clip jaws to close, also causing said actuating means to return to said first position.

3. A device as described in claim 1, wherein said actuating means is a string.

4. A device as described in claim 1, wherein said jaw has a feature which specifically contours to one or more gutter lip profiles.

5. A device as described in claim 1, wherein said light string retainer of said clip is a spring loaded member.

6. A device as described in claim 1, wherein said light string retainer of said clip is a hook member.

7. A device as described in claim 1, wherein said hanger clip actuator may be rotated on an axis essentially perpendicular to the axis along which said hanger clip jaw opens and closes.

8. A device as described in claim 7, wherein said hanger clip actuator and said elongated staff are engaged by locking means, to selectively and temporarily lock the hanger clip actuator at a desired rotation angle.

9. A device as described in claim 8, wherein said locking means is comprised of a screw and nut type combination, with screw axis essentially coincident with axis of rotation.
